(19) United States
(12) Patent Application Publication
(10) Pub. No.: US 2016/0253048 A1
(43) Pub. Date: Sep. 1, 2016

(54) SYSTEMS AND METHODS FOR GRAPHICALLY INDICATING AND ALLOCATING CONFERENCE RESOURCES

(71) Applicants: Chris Silcock, Kitchener (CA); Mark Weiss, Kitchener (CA)

(72) Inventors: Chris Silcock, Kitchener (CA); Mark Weiss, Kitchener (CA)

(21) Appl. No.: 14/632,398

(22) Filed: Feb. 26, 2015

(51) Int. Cl. G06F 3/0482; G06Q 10/02; H04L 29/06; G06F 3/0484; G06F 3/0485

(52) U.S. Cl. CPC G06F 3/0482; G06F 3/04842; G06F 3/04855; H04L 65/403; H04L 65/1069; G06Q 10/02

(57) ABSTRACT

According to one aspect, a method for graphically indicating and allocating conference resources. The method includes providing a location-resource data hierarchy, the location-resource data hierarchy having at least one collection of rooms, the at least one collection of rooms having at least one room, the at least one room having an associated location and an associated booking schedule, and displaying at least one room indicator associated with the at least one room in a room-collection view, wherein the at least one room indicator is displayed in accordance with the booking schedule of the corresponding at least one room.

### TECHNICAL FIELD

The embodiments disclosed herein relate to systems and methods administering organizational resources, and, in particular to systems and methods for graphically indicating and allocating conference resources.

### BRIEF DESCRIPTION OF THE DRAWINGS

The drawings included herewith are for illustrating various examples of articles, methods, and apparatus of the present specification. In the drawings:

FIG. 1 is a schematic diagram showing a system for graphically indicating and allocating conference resources according to some embodiments;

FIG. 2 is a block diagram showing a location-resource hierarchy, according to some embodiments;

FIG. 3 is a graphical representation of a collection of rooms displayed in a floorplan view according to some embodiments;

FIG. 4 is a graphical representation of the collection of rooms of FIG. 3 displayed in a floorplan view including a graphical representation of room status;

FIG. 5 is a graphical representation of the collection of rooms of FIG. 3 displayed in a floorplan view including selection tools; and

FIG. 6 is a flow chart showing a method for graphically indicating and allocating conference resources according to some embodiments.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed below that is not claimed in this document may be the subject matter of another protective instrument, for example, a continuing patent application, and the applicants, inventors or owners do not intend to abandon, disclaim or dedicate to the public any such invention by its disclosure in this document.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), at least one input device, and at least one output device. For example and without limitation, the programmable computers may be a mainframe computer, server, personal computer, laptop, personal data assistant, or cellular telephone. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

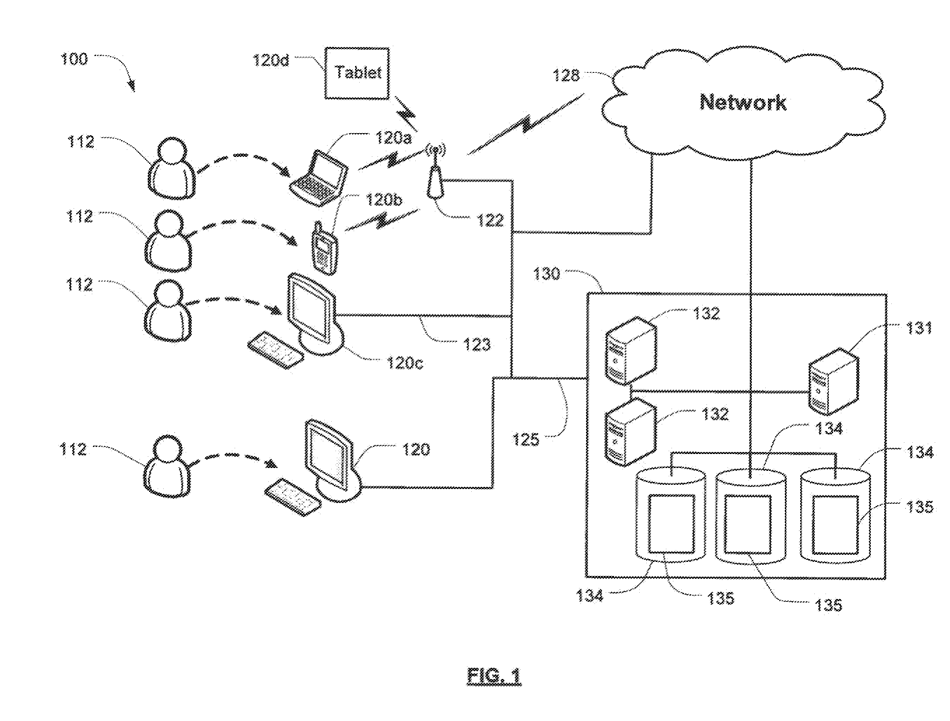

Turning now to FIG. 1, illustrated therein is a system 100 for graphically indicating and allocating conference resources according to one embodiment.

Using the system 100, one or more users 112 may communicate with a conference resource service provider 130 to in order to determine which conference resources (e.g. rooms) are available for use, and to reserve the use of those resources at a particular time.

The communication between the users 112 and the conference resource provider 130 can occur either directly or indirectly using any suitable computing device. For example, the user 112 may use a computing device 120 such as a desktop computer that has at least one input device (e.g. a keyboard and a mouse) and at least one output device (e.g. a display screen and speakers). The computing device 120 can generally be any other suitable device for facilitating communication between the users 12 and the conference resource service provider 130. For example, the computing device 120 could be a laptop 120a wirelessly coupled to an access point 122 (e.g. a wireless router, a cellular communications tower, etc.), a wirelessly enabled smart phone 120b, or a terminal 120c over a wired connection 123.

The computing devices 120 may be connected to the conference resource service provider 130 via any suitable communications channel. For example, the computing devices 120 may be communicate to the conference resource service provider 130 over a local area network (LAN) or intranet, or using an external network (e.g. by using a browser on the computing device 120 to browse to one or more web pages presented over the Internet 128).

In some examples, one or more of the users 12 may be required to authenticate their identities in order to communicate with the conference resource service provider 130. For example, the users 12 may be required to input a login name and/or a password to gain access to the services provided by the conference resource service provider 130. In such a case, a room reservation may be made corresponding to the authenticated identity.

In some embodiments, the wireless access points 122 may connect to the conference resources service provider 130 through a data connection 125 established over the LAN or intranet. Alternatively, the wireless access points 122 may be in communication with the conference resource service provider 130 via the Internet 128 or another external data communications network. For example, one user 112 may use a laptop 20a to browse to a webpage that displays elements of a system for graphically indicating and allocating conference resources. Another user 112 may use a smart phone 120b or tablet 120 dequipped with a specialized application that displays elements of a system for graphically indicating and allocating conference resources.

The conference resource service provider 130 generally includes a number of functional components for facilitating the provision of electronic learning services. For example, the educational service provider 130 generally includes one or more processing devices 132 (e.g. servers), each having one or more processors. The processing devices 132 are configured to send information (e.g. web page content) to be displayed on one or more computing devices 120 in association with the system 100. In some embodiments, the processing device 132 may be a computing device 120 (e.g. a laptop or personal computer).

The conference resource service provider 130 also generally includes one or more data storage devices 134 that are in communication with the processing devices 132 (e.g. servers), and could include a relational database, file system, or any other suitable data storage device. The data storage devices 134 are configured to host data 135 such as a location-resource hierarchy.

In some embodiments, the system 100 may also have one or more backup servers 131 that may duplicate some or all of the data 135 stored on the data storage devices 134. The backup servers 131 may be desirable to prevent data loss in the event of an accident such as a fire, flooding, hardware failure, or theft.

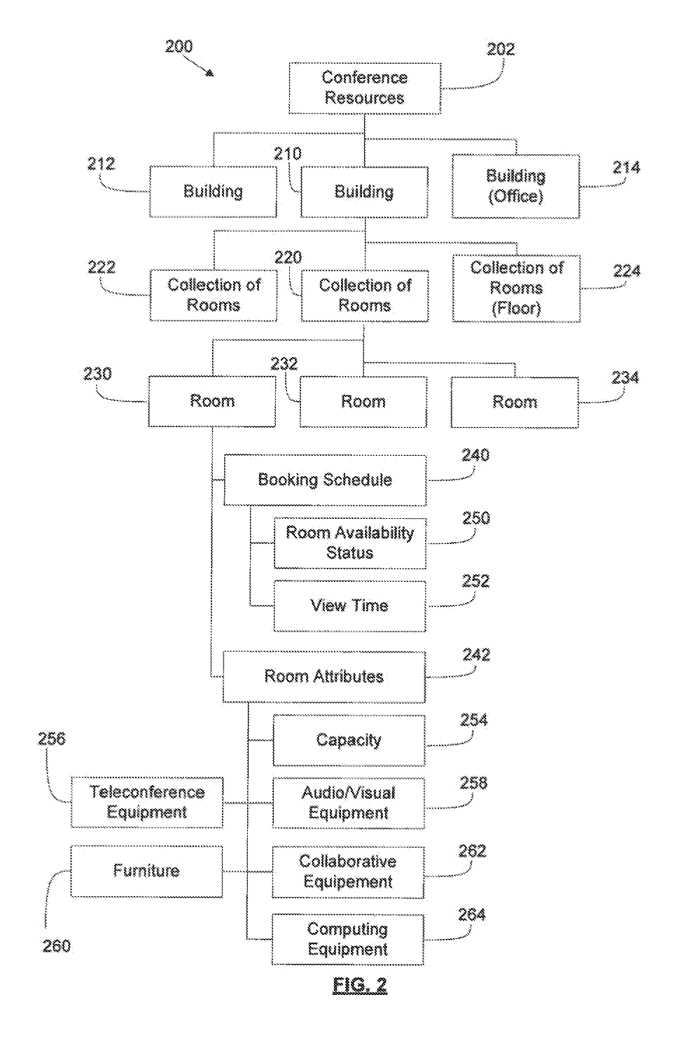

Referring to FIG. 2, there is shown an example of a location-resource hierarchy 200. The systems and methods for graphically indicating and allocating conference resources use a location-resource hierarchy. The location-resource hierarchy describes the relationships between a location and the conference resources located at or within the location. According to some embodiments, the location-resource hierarchy can include any or all of: buildings; collections of rooms; and rooms. Each room may have any or all of a booking schedule (including a room-availability status associated with a view time), and room attributes.

According to FIG. 2, conference resources 202 can be described in terms of the buildings, rooms, room booking schedules, and room attributes, according to a hierarchical relationship.

For example, conference resources 202 comprise three buildings: building 210, building 212, and building 214. In practice, there is no requirement or limit for the number of buildings that can comprise the conference resources 202.

The label “building” is used to describe the level of hierarchy comprising buildings 210, 212, and 214. In some implementations, “building” may refer to a specific office, as indicated by building 214, such as a regional office. For example, an organization such as a corporation may have regional offices in St. Agatha, Petersburg, and Baden. In such a case, “building” may refer to the Baden office (regardless of how the Baden office of the organization may correspond to all or part of the particular office tower in which it is used).

In other implementations, “building” may refer to a specific building structure. For example, an organization such as a large corporation or a university may be housed in multiple structures within a campus, such as “Building 1”, “Building 2”, etc., or “the Science Building”, “the Engineering Building”, etc. In such a case, “building”, as used to describe the location-resource hierarchy 200 herein, may refer to “Building 1” or “the Science building” on a campus.

It is also possible to accommodate a scenario in which an organization is housed on multiple campuses, each having multiple buildings, such as by adding an extra level to the location-resource hierarchy 200.

In essence, as used herein, “building” means an aggregation of room collections. The label “building” has been used herein in order to provide a tangible, concrete example, since, in most situations, collections of rooms will be defined by location, and generally contained within the same physical building.

Each building 210, 212, and 214 comprises a collection of rooms. For simplicity of illustration, only the collections of rooms for building 210 have been shown.

Building 210 can be described in terms of collections of rooms 220, 222, and 224. In practice, there is no requirement or limit for the number of collections of rooms that can comprise the building 210.

The label “collection of rooms” is used to describe the level of hierarchy comprising the collections of rooms 220, 222, and 224. In some implementations, a “collection of rooms” will refer to a particular floor within a building, as indicated by collection of rooms 224. For example, a building may have multiple floors, with each floor comprising separate rooms. In such a case, “collection of rooms”, as used to describe the location-resource hierarchy 200 herein, may refer to a specific floor in a building.

In other cases, a collection of rooms may be organized according to such things as: security perimeters, pre-determined exclusive allocation of rooms to a particular department within an organization, etc. For example, a collection of rooms may comprise all of the rooms on a particular floor that are within a secured area, or which are for the exclusive use of the legal department or research department.

Each collection of rooms 220, 222, and 224 comprises individual rooms. For simplicity of illustration, only the rooms for the collection of rooms 220 have been shown.

The collection of rooms 220 can be described in terms of the individual rooms 230, 232, and 234. In practice, there is no requirement or limit for the number of collections of rooms that can comprise the collection of rooms 220.

The label “room” is used to describe the level of hierarchy comprising rooms 230, 232, and 234. In some implementations, a “room” will refer to a physical room with a particular location, for example, as defined on a particular floor within a particular building.

Each room may have an associated booking schedule 240. A booking schedule is a record that indicates the use of the room with respect to time, as described by a room-availability status 250 and a view time 252.

According to some embodiments, the booking schedule may include more details than the room-availability status 250 and the view time 252. For example, a booking schedule may include details such as the identity of the user that booked the room during a particular time, the identity of other meeting attendees, the name or subject of the meeting, what resources are required for the booking, etc.

Generally speaking, the room-availability status 250 can take values such as “available” or “unavailable”. The view time can be time slot defined as a start time and a duration, or a start time and an end time, etc.

In addition to the booking schedule 240, each room 230 may be associated with room attributes 242. These attributes may include, but are not limited to such things as room capacity 254, audio/video equipment 258, teleconferencing equipment 256, collaborative display equipment 262, computing equipment 264, and furniture 260.

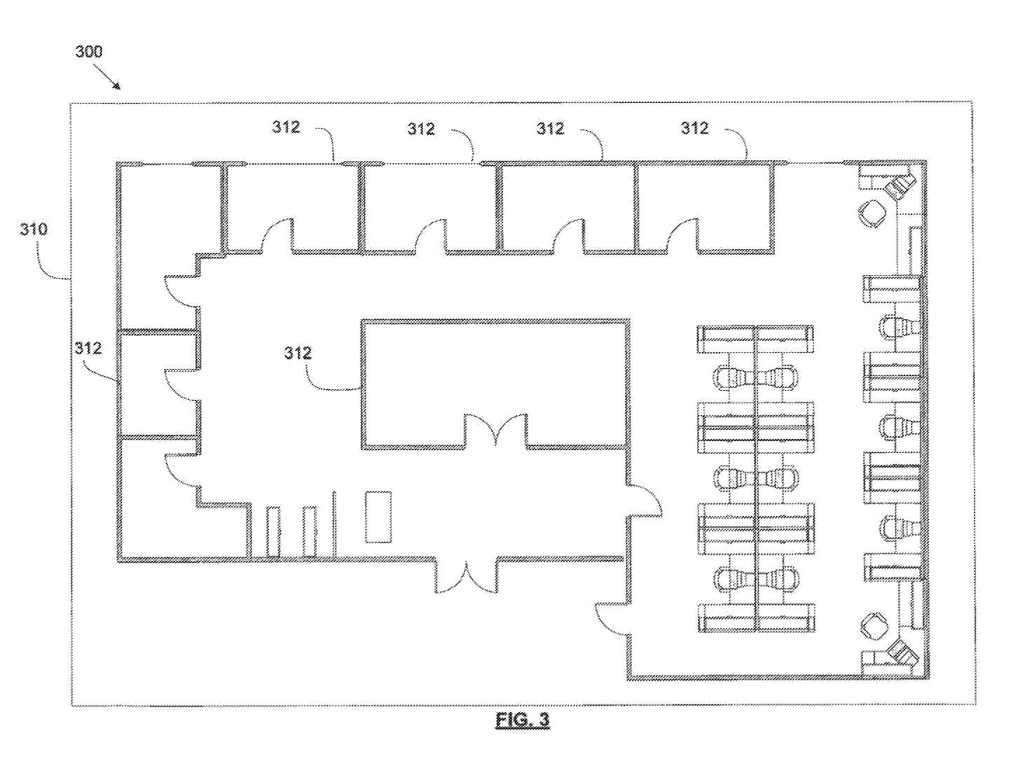

Referring to FIG. 3, there is shown a collection of rooms 300 displayed in a floorplan view 310. According to some embodiments, the collection of rooms 300 displayed in a floorplan view 310 may be part of a graphical user interface. The collection of rooms 300 comprises a plurality of room indicators 312. Each room indicator 312 corresponds to a room as defined in a location-resource hierarchy.

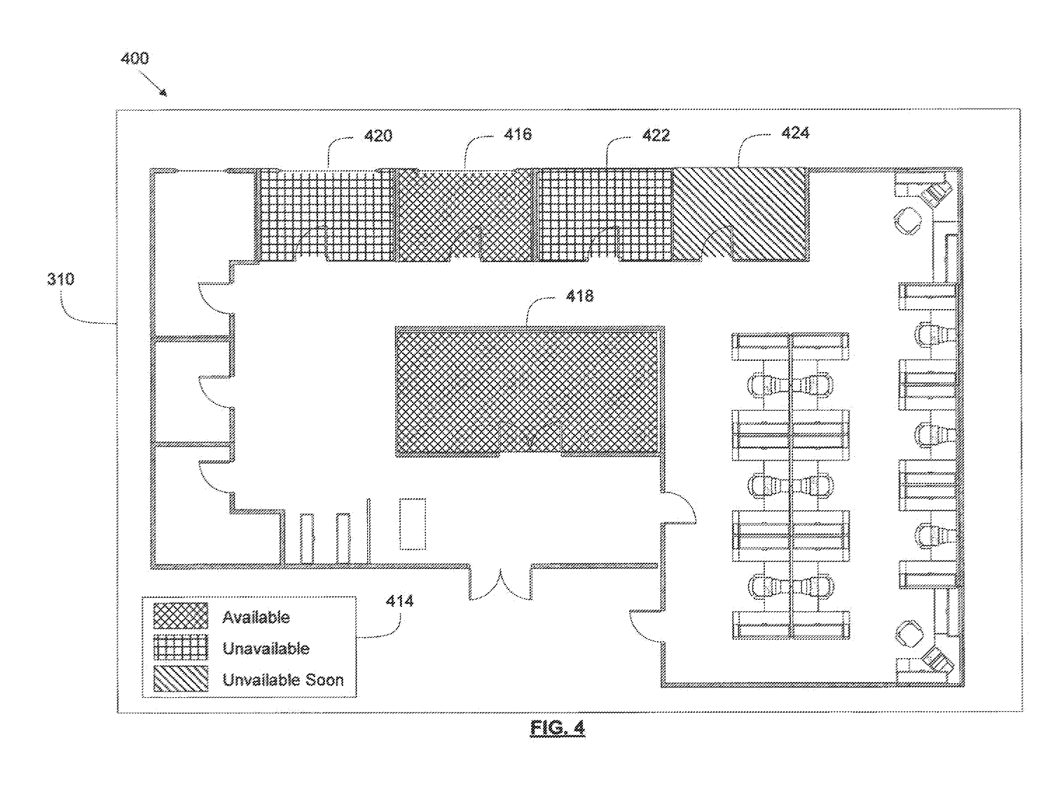

Referring to FIG. 4, there is shown a graphical user-interface 400, which includes a collection of rooms displayed in a floorplan view 310. The graphical user-interface 400 can be used to display the room-availability status for any of the rooms in the collection of rooms 310 for a particular time. As indicated by the room-status key 414, room indicators 416 and 418 indicate that their associated rooms are “available” at the given time. Similarly, room indicators 420 and 422 indicate that their associated rooms are “unavailable” at the given time. Room indicator 424 indicates that its associated room is “unavailable soon” in respect of the given time.

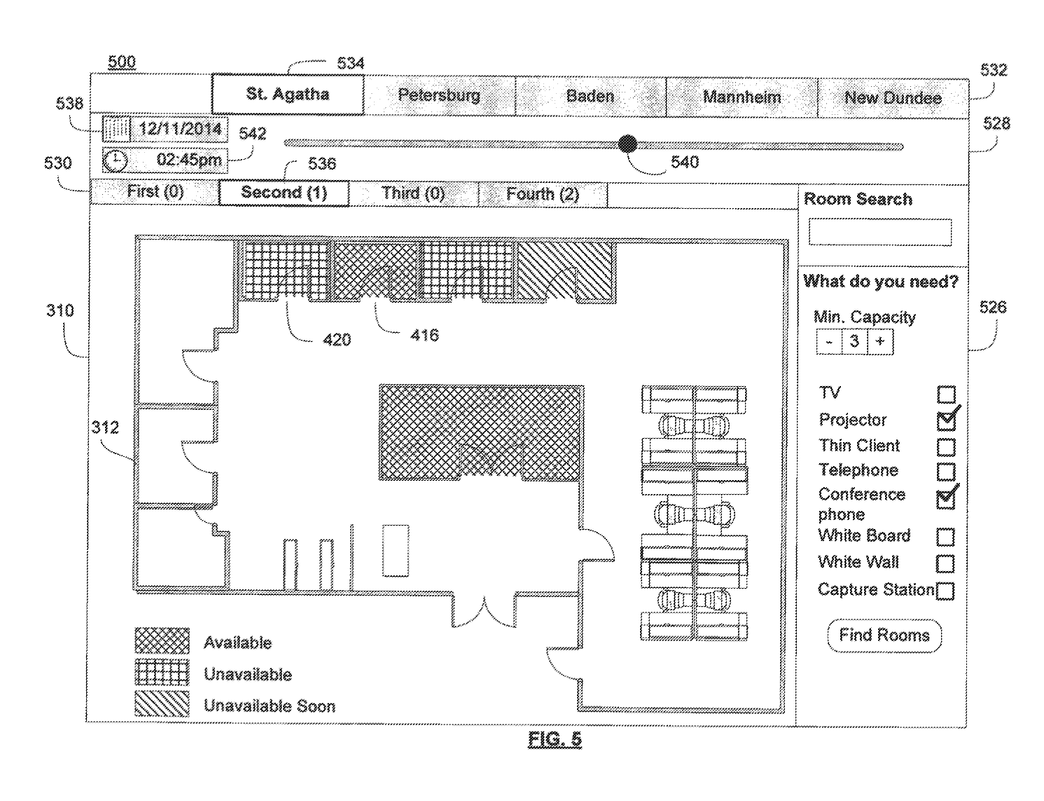

Referring to FIG. 5, there is shown a graphical user-interface 500, displaying a collection of rooms in a floorplan view 310. The collection of rooms comprises a plurality of room indicators 312, 416, 420 (and others not enumerated). Each room indicator corresponds to a room as defined in a location-resource hierarchy.

The graphical user-interface 500 can be used to display the room-availability status for any of the rooms in the collection of rooms, in the same way as was described for the graphical user-interface 400.

A room-attribute selector 526, a view-time selector 528, a room-collection selector 530, and a building selector 532 are included in the graphical user-interface 500.

As shown in the example of FIG. 5, a building selector 532 can comprise individual tabs or buttons 534 for each building included in the location-resource hierarchy. As such, a user can select a particular building by choosing the corresponding tab or button 534. As shown in the example of FIG. 5, there are individual tabs or buttons for each of St. Agatha, Petersburg, Baden, Mannheim, and New Dundee. The St. Agatha button 524 is displayed in a different manner from the other buttons in order to indicate that the St. Agatha button 524 has been selected; in other words, the floorplan view 310 corresponds to a collection of rooms associated with the St. Agatha building.

Similarly, a room-collection selector 530 can comprise individual tabs or buttons 536 for each room collection (e.g. floor) included in the selected building. As such, a user can select a particular room collection by choosing the corresponding tab or button 536. As shown in the example of FIG. 5, there are individual tabs or buttons for each of the first floor, second floor, third floor, and fourth floor (within the St. Agatha building). The second floor button 536 is displayed in a different manner from the other buttons in order to indicate that the second floor button 536 has been selected; in other words, the floorplan view 310 corresponds to the second floor of the St. Agatha building.

Each of the tabs or buttons or buttons in the room-collection selector 430 displays a label that includes the name of the room collection (e.g. “Second” floor), as well as an indication of the number of available rooms (e.g. “(1)”). As such, a user using the user interface 500 can quickly determine, at a glance, whether a floor has any rooms available according to the user's criteria. In the example shown, the label “First (0)” indicates that there are no available rooms on the first floor, and, therefore, based on this information, a user may decide not to select the button or tab corresponding to the first floor.

When a user selects a new building by using a tab or button 534, room-collection selector 530 is adjusted in order to display the room collections that are associated with the selected building, according to the location-resource hierarchy.

Similarly, when a user selects a new room collection by using the room-collection selector 530, the floorplan view 310 displaying the collections of rooms is adjusted in order to display the room indicators that are associated with the selected collection of rooms, according to the location-resource hierarchy. A default collection of rooms, such as the first floor, can be automatically displayed immediately after a user selects a new building, but before a new collection of rooms is selected.

The view-time selector 528 includes both a calendar-view date selector 538 as well as a slider-bar time selector 540. Using these selectors, a user can select a particular time on a particular date. The selected time and date are displayed on the calendar-view date selector 538 and the time display 542. When a user selects a particular time on particular date, the display of the room indicators 312, 416, and 420 is changed in accordance with the associated booking schedules.

The room attribute selector 526 lists all of the individual attributes that might be associated with any particular room within a collection of rooms or building. For example, any given room may be defined in terms of a capacity (e.g. number of people who can comfortably use the room at one time). Any given room may include attributes such as audio/visual equipment, collaborative display equipment, computing equipment, teleconferencing equipment, furniture, etc.

Using the room attribute selector 526, a user can select particular attributes that are desired for the room that he or she wishes to view or book. For example, a user may require a room with a conference phone and projector. When a user selects particular attributes, the room indicators 526 in the room collection view 310 can be displayed according to whether they meet the criteria of the selected attributes. In other words, the room attribute selector 526 can be used to filter out rooms that do not meet the user's particular requirements.

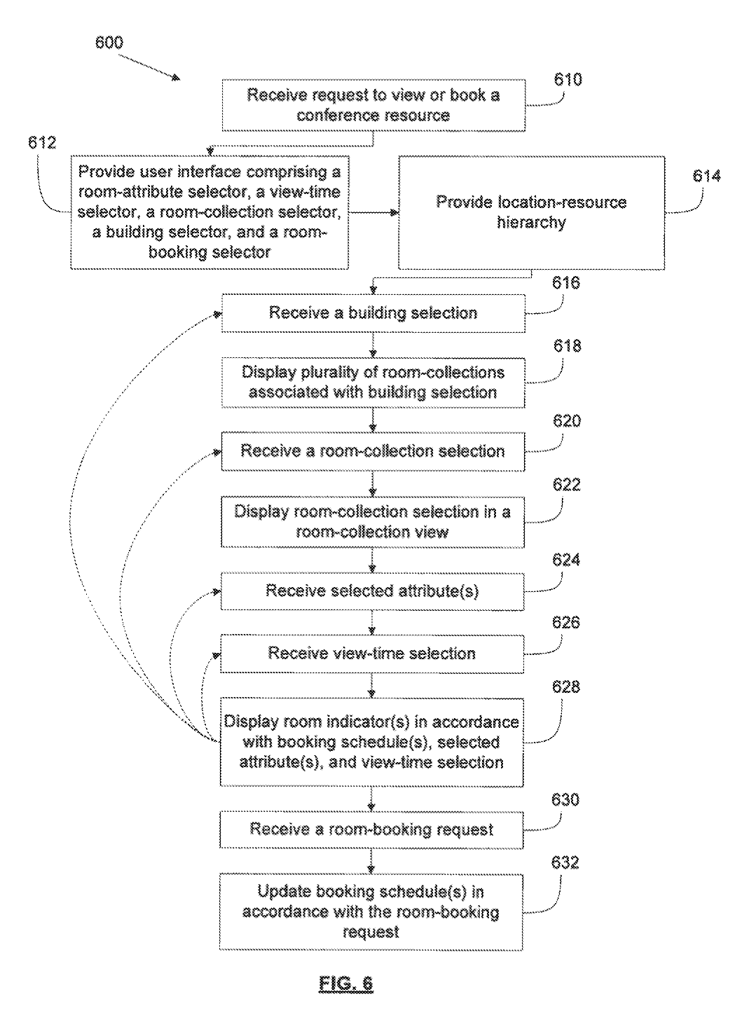

Referring to FIG. 6, there is shown a method for graphically indicating and allocating conference resources. The method begins at step 610, when a request to view or book a conference resource is received. For example, a request to view or book a conference resource may be received by a system for graphically indicating and allocating conference resources, as described herein.

In some cases a user, such as a member of an organization using a system for graphically indicating and allocating conference resources may desire to view the use of conference resources within the organization, or to book or reserve conference resources within the organization. For example, the user may wish to book a conference room for a meeting.

At steps 612 and 614, a user interface is provided along with a location-resource hierarchy. The user interface comprises a room-attribute selector, a view-time selector, a room-collection selector, a building selector, and a room-booking selector, as previously described.

At 616, a building selection is received. The building selection corresponds to the building selected by the user using the building selector. For example, if an organization is located across the buildings identified as “St. Agatha”, “Petersburg”, and “Baden”, then the user may select one of these buildings using the building selector.

At 618, the room collections associated with the selected building are made available within the room-collection selector in the user interface. For example, if the St. Agatha building has four floors, and if each floor corresponds to its own room collection, then the room-collection selector will make a choice available to the user for selecting one of the four floors. If, at step 516, the user had selected the “Petersburg” building, then the room collections associated with the Petersburg building, according to the location-resource hierarchy, would be displayed within the room-collection selector.

At 620, a room-collection selection is received. The room-collection selection corresponds to the room collection selected by the user using the room-collection selector in the user interface. For example, if the St. Agatha building has four floors, and if each floor corresponds to its own room collection, then the user may select one of these floors using the room-collection selector.

At 622, the room-collection selection is displayed in a room-collection view. According to some embodiments, a room-collection may be displayed by displaying individual room indicators, whereas, in other embodiments, a room-collection may be displayed as a single image on top of which corresponding room indicators may be overlaid. Generally speaking, a room collection can be displayed, or described, as a collection of rooms or room indicators.

According to some embodiments, the room indicators that comprise the room collection can be arranged in a meaningful or purposeful manner, known as a room-collection view. For example, the room indicators comprising a room collection may be arranged in a room-collection view consisting of a floorplan view. In this arrangement, the rooms in the room collection, or the room indicators, are spatially arranged to correspond to the actual rooms in the building that they represent. The floorplan view may be to scale, or not to scale, and may include any or all rooms that exist in the actual building.

In another example, the room indicators comprising a room collection may be arranged in a grid view, in which the rooms (or room indicators) are arranged in rows. Multiple grid views are possible, such as, but not limited to, grid views in which the columns represent different times and/or room attributes.

It is not necessary that the rows in a grid view represent rooms. An inversion of the grid view described above is possible, in which the rooms (or room indicators) are arranged in columns, and the view times and/or room attributes are arranged in rows.

At the point of 622 in the method, a user has effectively selected a building and a floor (room collection) in which he or she would like to view a room's usage and availability, and/or book the room. In some cases, a default building and/or room collection will be provided; in other words, even if a user has not actively selected a building and/or room collection, a default room collection may be displayed nonetheless. In other cases, an organization may be located in a single building, and/or organized in a single room collection (e.g. located on a single floor in one building). In this case, it is not necessary to provide a building selector or room-collection selector; and the only building and/or room collection pertaining to the organization may be treated as a default.

At 624, room attributes are received. These attributes can be selected by a user using the room-attribute selector in the user interface. These attributes may include, but are not limited to such things as room capacity, audio/video equipment, teleconferencing equipment, collaborative display equipment, computing equipment, and furniture. The selection of particular attributes allows the user to identify, or narrow the search for particular rooms that meet the criteria of selected attributes.

For example, if a user desires to book a meeting in order to give a presentation to nine colleagues in the same office, and five colleagues in remote locations, then the user may require a room with a capacity of at least ten people, teleconferencing equipment, and presentation equipment (e.g. audio/video, collaborative display such as a white board or electronic board), etc.

According to some embodiments, a user may be able to apply different logic to the attribute selection. For example, a user may be able to select rooms with a capacity of at least ten people, but fewer than twenty people. A user may also be able to select rooms with a conference table and chairs, but with no bean-bag chairs.

At 626, a view-time selection is received. The view-time selection corresponds to the view time selected by the user using the view-time selector in the user interface. For example, a user may want to determine which rooms are available at a particular time, for a particular duration, during particular day.

At 628, room indicators are displayed in accordance with their associated booking schedules, selected attributes, and view-time selections.

Room indicators can be displayed in accordance with their status. Examples of status include, but are not limited to: “available”, “unavailable soon”, “unavailable”, “reserved”, and “filtered”. The status may be determined based on any or all of the booking schedules associated with a particular room, selected attributes, and view-time selections.

A room indicator may be displayed with a specific representation that corresponds to its room-availability status. According to some embodiments, the representations may be graphical such as by using words, colors, patterns, symbols, shading, etc.

Once a user has made a particular building selection, room-collection selection, view-time selection, and has selected particular room attributes, then the room-availability status can be determined. For example, a user may select the fourth floor of the St. Agatha building, and choose rooms with a capacity greater than six people, having a conference table. The room indicator corresponding to each room on the fourth floor of the St. Agatha building will be displayed according to its status at the time corresponding to the view-time selection.

Continuing with the above example, any rooms that do not meet the criteria of the selected attributes may have a status of “filtered”. In this case, the room indicator associated with the room may be displayed as greyed out, or with a particular color or pattern or word. In this case, it may be advantageous to use a graphical representation, such as the color grey, which is relatively innocuous, and which does not immediately grab viewer's attention. In such a case, it may be more appropriate to draw a viewer's attention to the rooms that meet the criteria of his or her selected attributes.

Continuing with the above example, any rooms that meet the criteria of the selected attributes, but whose associated booking schedule indicates that the room is unavailable at the time of the view-time selection may have the status of “unavailable”. In this case, the room indicator associated with the room may be displayed as red, or with a particular color or pattern or word. As described above for the “filtered” status, there may be advantageous colors, patterns, or words that convey or suggest the status “unavailable”. Red is used as a suggestion, but the particular representation need not be red.

Continuing with the above example, any rooms that meet the criteria of the selected attributes, and whose associated booking schedule indicates that the room is available at the time of the view-time selection may have the status “available”. In this case, the room indicator associated with the room may be displayed as green, etc.

According to some embodiments, a room-availability status of “unavailable soon” may be determined by evaluating a booking schedule immediately after the time of the view-time selection. This may be helpful, for example, if a room is needed for a meeting of indeterminate length, or which might run over the expected time duration. This may also be helpful when the view-time selection corresponds to real time (i.e. a user is looking at the current status of rooms), since this will assist a user in determining that they can meet in a particular room, but only if they act promptly.

According to some embodiments, more than one status may be associated with the same representation. For example, rooms that are unavailable as well as rooms that do not meet the criteria of the selected attributes may both be greyed out, or otherwise made to look the same, since a user is generally disinterested in booking them.

When the room-collection view comprises a grid view, and the columns of the grid represent different view times, the selected view time can be used as a key column, and then other columns can be automatically created for other view times adjacent to the selected view time. The duration of each view time (e.g. a time slot) may be automatically set, be based on a default value (such as half-hour or one-hour, to accommodate default meeting lengths), or can be determined by a user.

At any point along the method, for example, after the room indicators have been displayed at 628, a user may make different building selection, room-collection selection, room-attribute selection, view-time selection, etc. The method may return to any of the preceding steps, such as 616, 620, 624, and 626, so that display of the room indicators can be updated accordingly. As such, a user may navigate through different buildings, floors, and times, and alter the selected attributes. Some of these interactions are generally indicated by the stippled lines in FIG. 6.

At 630, a room-booking request is received. The room-booking request corresponds to a particular room at a particular time. In some embodiments, the room-booking request may be determined by the room-availability status. For example, a user may desire to reserve or book a particular room, and may select a room based on the room-availability status represented in the display of the room indicator at the time of the view-time selection. In this case, the user may select the room, for example, by clicking on the room indicator, or by otherwise entering an identifier for the room.

According to some embodiments, a booking time corresponding to the time of the view-time selection may be implicitly selected, or automatically assigned by the system. In other embodiments, a user may explicitly provide a booking time.

The selected room and the booking time comprise the room-booking request. A user may then submit the room-booking request, for example, using a “submit” button provided in the user interface, in order to submit the room-booking request. Once a room-booking request is submitted, it can be received at 630.

At 632, the booking schedule associated with the selected room in the room-booking request is updated. Updating the booking schedule may comprise, for example, changing the booking schedule to a status of “unavailable” for the duration of the booking time. According to some embodiments, the booking schedule may include more details than simply an “available/unavailable” status. For example, a booking schedule may include details such as the identity of the user that booked the room during a particular time, the identity of other meeting attendees, the name or subject of the meeting, what resources are required for the booking, etc.

While the above description provides examples of one or more apparatus, methods, or systems, it will be appreciated that other apparatus, methods, or systems may be within the scope of the claims as interpreted by one of skill in the art.

1. A method for graphically indicating and allocating conference resources, comprising:
a) providing a location-resource data hierarchy, the location-resource data hierarchy having at least one collection of rooms;
the at least one collection of rooms having at least one room;
the at least one room having an associated location and an associated booking schedule;
b) displaying at least one room indicator associated with the at least one room in a room-collection view, wherein the at least one room indicator is displayed in accordance with the booking schedule of the corresponding at least one room.

2. The method of claim 1, wherein the room-collection view is either a floorplan view or a grid view.

3. The method of claim 1, wherein the at least one room has a plurality of associated attributes, and the method further comprises:
c) providing an attribute selector for selecting at least one attribute from the plurality of attributes;
d) receiving the at least one selected attribute from the plurality of attributes; and,
e) displaying the at least one room indicator in accordance with the selected attributes.

4. The method of claim 3, wherein the plurality of associated attributes includes at least one of: room capacity; audio/video equipment; teleconferencing equipment; collaborative display equipment; computing equipment; and furniture.

5. The method of claim 1, wherein the booking schedule includes a room-availability status associated with a view time; and,
displaying the at least one room indicator comprises displaying the at least one room indicator with at least one of a color, a pattern, a symbol, or a shading corresponding to the room-availability status associated with the view time.

6. The method of claim 0, further comprising:
f) providing a view-time selector for selecting a view-time selection;
g) receiving the view-time selection; and,
h) displaying the at least one room indicator in accordance with the room-availability status associated with the view-time selection.

7. The method of claim 0, wherein the view-time selector is at least one of a slider bar and a calendar view.

8. The method of claim 1, further comprising:
i) providing a room-collection selector for selecting a room-collection selection from a plurality of collections of rooms; and,
j) receiving a room-collection selection;
wherein the at least one collection of rooms is the room-collection selection, and the room is associated with the at least one collection of rooms according to the location-resource hierarchy.

9. The method of claim 0, further comprising:
k) providing a building selector for selecting a building from a plurality of buildings; and,
l) receiving a building selection;
wherein the collection of rooms is associated with the building selection according to the location-resource hierarchy.

10. The method of claim 1, further comprising:
l) receiving a room-booking request; and,
m) updating the booking schedule in accordance with the room-booking request.

11. A system for graphically indicating and allocating conference resources, comprising:
a computer-readable non-transient medium for storing a location-resource data hierarchy;
a graphical display unit for displaying a graphical user-interface; and,
a processor in communication with the computer-readable non-transient medium, the graphical display unit, and the user input device, the processor configure to:
provide a location-resource data hierarchy, the location-resource hierarchy having at least one collection of rooms;
the at least one collection of rooms having at least one room;
the at least one room having an associated location and associated booking schedule; and,
display at least one room indicator on the graphical user-interface, the at least one room indicator being associated with the at least one room in a room-collection view, wherein the at least one room indicator is displayed in accordance with the booking schedule of the corresponding at least one room.

12. The system of claim 11, wherein the room-collection view is either a floorplan view or a grid view.

13. The method of claim 11, wherein the at least one room has a plurality of associated attributes, and the processor is further configured to:
provide an attribute selector on the graphical user-interface for selecting at least one attribute from the plurality of attributes;
receive the at least one selected attribute from the plurality of attributes; and,
display the at least one room indicator on the graphical user-interface in accordance with the selected attributes.

14. The system of claim 13, wherein the plurality of associated attributes includes at least one of: room capacity, audio/video equipment, teleconferencing equipment, collaborative display equipment, computing equipment, and furniture.

15. The system of claim 11, wherein the booking schedule includes a room-availability status associated with the view time; and,
displaying the at least one room indicator on the graphical user-interface comprises displaying the at least one room indicator with at least one of a color, a pattern, a symbol, or a shading corresponding to the room-availability status associated with the view time.

16. The system of claim 15, wherein the processor is further configured to:
provide a view-time selector on the graphical user-interface for selecting a view-time selection;
receive the view-time selection; and,
display the at least one room indicator on the graphical user-interface in accordance with the room-availability status associated with the view-time selection.

17. The system of claim 16, wherein the view-time selector is at least one of a slider bar and a calendar view.

18. The system of claim 11, wherein the processor is further configured to:
provide a room-collection selector on the graphical user-interface for selecting a room-collection selection from a plurality of collections of rooms; and,
receive a room-collection selection;
wherein the at least one collection of rooms is the room-collection selection, and the room is associated with the at least one collection of rooms according to the location-resource hierarchy.

19. The system of claim 18, wherein the processor is further configured to:
provide a building selector on the graphical user-interface for selecting a building from a plurality of buildings; and,
receive a building selection;
wherein the collection of rooms is associated with the building selection according to the location-resource hierarchy.

20. The system of claim 11, wherein the processor is further configured to:
receive a room-booking request; and,
update the booking schedule in accordance with the room-booking request.
